(19) United States
(12) Patent Application Publication
(10) Pub. No.: US 2026/0353408 A1
(43) Pub. Date: Nov. 5, 2026

(54) OPTIMIZED REPORTING OF SIDELINK SENSING AND RESOURCE RESERVATION INFORMATION

(71) Applicant: TOYOTA JIDOSHA KABUSHIKI KAISHA, Toyota-shi, Aichi-ken (JP)

(72) Inventors: Daniel MEDINA, Munchen (DE); Torsten WILDSCHEK, Gloucester (GB); Ling YU, Kauniainen (FI); Nuno KIILERICH PRATAS, Gistrup (DK); Faranaz SABOURI-SICHANI, Aalborg Oe (DK); Takayuki SHIMIZU, Mountain View, CA (US); Claude ARZELIER, Varna (BG); Kai-Erik SUNELL, Naantali (FI)

(73) Assignee: TOYOTA JIDOSHA KABUSHIKI KAISHA, Toyota-shi, Aichi-ken (JP)

(21) Appl. No.: 19/102,678

(22) PCT Filed: Aug. 3, 2023
(86) PCT No.: PCT/JP2023/028379

§ 371 Date: Feb. 10, 2025

(51) Int. Cl. H04W 72/25; H04B 17/318

(52) U.S. Cl. CPC H04W 72/25; H04B 17/318

(57) ABSTRACT

A method and user equipment are provided for sharing radio resource information. The method includes receiving first sidelink control information (SCI) at a first radio access technology (RAT) module, wherein the first RAT module is configured to implement a first RAT. At least one first radio resource is determined based on the first SCI. First information associated with the first SCI is transmitted to a second RAT module, wherein the second RAT module is configured to implement a second RAT, the second RAT being different from the first RAT. Second SCI is received at the first RAT module. At least one second radio resource is determined based on the second SCI. Whether to transmit second information associated with the second SCI to the second RAT module is determined based on at least whether the determined at least one first radio resource matches the determined at least one second radio resource.

### CROSS-REFERENCE TO RELATED APPLICATIONS

This application claims the benefit of priority of U.S. Provisional Patent Application No. 63/396,896, filed on Aug. 10, 2022, the entirety of which is incorporated by reference herein.

### TECHNICAL FIELD

This disclosure generally relates to sidelink sensing information sharing, and more particularly to sidelink sensing information sharing between a first radio access technology (RAT) module in a user equipment (UE) and a second RAT module.

### BACKGROUND ART

Spectrum efficiency is important for radio communication systems. Usually, scarce spectrum resources are geographically reused among multiple users and therefore radio communication systems are limited by co-channel interference or contamination of an information bearing signal by another similar kind of signal at the receiving antenna. An example of such a system is cellular communications where efficient spectrum utilization generally requires complex resource allocation procedures based on radio measurements. A problem may arise if users cannot perform radio measurements.

Sidelink communication is used in 3GPP radio interfaces to allow two (or more) user equipments (UEs) (e.g., wireless devices) to directly communicate with each other. This may happen under the coverage of a cellular network, out of coverage of the cellular network, or in partial coverage of the cellular network where only one of the two UEs is under the cellular network coverage. Sidelink communication facilitates efficient spectrum reuse, e.g., in direct communication in automotive applications. The device-to-device direct communication uses the PC5 interface for the example of 3GPP sidelink.

When a first device in a first sidelink communication shares radio resources with a second device in a second sidelink communication, the first device and the second device select radio resources for use. To select radio resources, the first device or the second device obtains resource reservation information and/or channel sensing information. Sometimes, a direct exchange of such information between two devices may not be possible. For example, while the first device is equipped with modules for both the first and second sidelink communications and is able to decode the resource information related to the second sidelink communication, the second device may only have a module for the second sidelink communication and thus, is unable to decode the resource information related to the first sidelink communication, causing inefficient and unfair resource allocation. Improved systems and methods for sharing resource reservation information and/or channel sensing information are desired.

The resource selection procedure of 3rd Generation Partnership Project (3GPP) Release 16/17 5G NR-V2X PC5 mode 2 is specified in 3GPP TS 38.213, TS 38.214, and TS 38.321. For resource selection, a user equipment (UE) performs channel sensing in a sensing window and collects other UE's resource reservation information based on sidelink control information (SCI) decoding to identify candidate resources in a selection window T (T=[T1, T2]). First, the UE excludes some time slots from the selection window due to unmonitored resources in the sensing window that the UE cannot sense due to its own transmission (i.e., half-duplex constraint). Then, the UE further excludes resources reserved by other UEs from the selection window if the corresponding sidelink-reference signal received power (SL-RSRP) exceeds the (pre-)configured SL-RSRP exclusion threshold. After resource exclusion, the number of candidate resources may be at least X % of the total number of resources in the selection window. Otherwise, the UE increases the SL-RSRP exclusion threshold by 3 dB (for example) until obtaining at least X & resources, where X is (pre-)configured from, for example, 20%, 35%, or 50%. Finally, the UE randomly selects resources among candidate resources in the selection window. The selected frequency resource can be used for multiple times with a fixed time interval for subsequent transmissions (i.e., semi-persistent scheduling (SPS)) or only once (i.e., one-shot transmission (OST)). Also, the UE can retransmit packets multiple times (i.e., hybrid automatic repeat request (HARQ) retransmissions) with or without feedback from receiver UEs to improve the reliability.

For a UE to perform sensing and obtain information to receive other UE's packets, the UE decodes SCI first. In Rel-16, there are 1st-stage SCI (SCI format 1-A) and 2nd-stage SCI (SCI format 2-A or 2-B) as defined in 3GPP TS 38.212. 1st-stage SCI carries resource reservation information for future transmissions, as well as information about resource allocation and modulation and coding scheme (MCS) for physical sidelink shared channel (PSSCH), demodulation reference signal (DMRS) pattern, 2nd-stage SCI format, etc. 2nd-stage SCI carries control information for HARQ procedures, source/destination IDs, information for distance-based groupcast (UE's zone identification (ID) and communication range requirement), etc. Based on a resource reservation contained in 1st-stage SCI, each UE avoids using reserved time/frequency resources by other UEs when it performs resource (re-)selection.

In Rel-17 5G NR-V2X PC5 mode 2, inter-UE coordination (IUC) is introduced, in which a UE-A sends coordination information about resources to a UE-B, and then the UE-B utilizes that information for its resource (re-)selection. Two schemes of inter-UE coordination are supported.

In IUC scheme 1, a UE-A can provide to another UE-B indications of resources that are preferred to be included in UE-B's (re-)selected resources, or preferred to be excluded. When given resources to include, UE-B may rely only on those resources, at least if it does not support sensing/resource exclusion, or may combine them with resources identified by its own sensing procedure, before making a final selection. The indication from UE-A to UE-B is sent in a medium access control (MAC) control element (CE) and/or 2nd-stage SCI.

In IUC scheme 2, a UE-A can provide to another UE-B an indication that resources reserved for UE-B's transmission (which may or may not be to UE-A) will be, or could be, subject to conflict with a transmission from another UE. Then, UE-B re-selects new resources to replace them. The indication from UE-A to UE-B may be sent in a physical sidelink feedback channel (PSFCH).

In some situations, an internal vehicle interface (e.g., a communications bus when the UE is implemented in a vehicle) connecting two radio access technology (RAT) modules (e.g., an LTE vehicle-to-everything (V2X) module and a 5G New Radio (NR) V2X module) may have limited remaining capacity, e.g., while in use by other bandwidth-intensive applications (such as camera or radar applications). Moreover, collisions may occur between protocol data unit (PDU) transmissions on the shared medium, leading to increased latency (e.g., due to retransmissions) and consequently performance degradation for all interface users (including legacy applications). Thus, it is desirable to minimize bandwidth requirements for sharing sensing and resource reservation information between two RAT modules.

### SUMMARY OF INVENTION

In some embodiments, a method for sharing radio resource information is provided. The method includes receiving first sidelink control information (SCI) at a first radio access technology (RAT) module, wherein the first RAT module is configured to implement a first RAT. At least one first radio resource is determined based on the first SCI. First information associated with the first SCI is transmitted to a second RAT module, wherein the second RAT module is configured to implement a second RAT, the second RAT being different from the first RAT. Second SCI is received at the first RAT module. At least one second radio resource is determined based on the second SCI. Whether to transmit second information associated with the second SCI to the second RAT module is determined based on at least whether the determined at least one first radio resource matches the determined at least one second radio resource.

In some embodiments, a user equipment (UE) for sharing radio resource information is provided. The UE includes a memory configured to store instructions and a processor configured to execute the instructions stored in the memory. The processor is configured to receive first sidelink control information (SCI) at a first radio access technology (RAT) module in the UE, wherein the first RAT module is configured to implement a first RAT; determine at least one first radio resource based on the first SCI; transmit first information associated with the first SCI to a second RAT module, wherein the second RAT module is configured to implement a second RAT, the second RAT being different from the first RAT; receive second SCI at the first RAT module; determine at least one second radio resource based on the second SCI; and determine whether to transmit second information associated with the second SCI to the second RAT module based on at least whether the determined at least one first radio resource matches the determined at least one second radio resource.

In some embodiments, a non-transitory computer-readable medium storing instructions that are executable by one or more processors of a user equipment (UE) in a communication network to perform a method is provided. The method includes receiving first sidelink control information (SCI) at a first radio access technology (RAT) module, wherein the first RAT module is configured to implement a first RAT. At least one first radio resource is determined based on the first SCI. First information associated with the first SCI is transmitted to a second RAT module, wherein the second RAT module is configured to implement a second RAT, the second RAT being different from the first RAT. Second SCI is received at the first RAT module. At least one second radio resource is determined based on the second SCI. Whether to transmit second information associated with the second SCI to the second RAT module is determined based on at least whether the determined at least one first radio resource matches the determined at least one second radio resource.

The above and other aspects and their implementations are described in greater detail in the drawings, the descriptions, and the claims.

### BRIEF DESCRIPTION OF DRAWINGS

FIG. 1 is a schematic diagram illustrating device types for dynamic co-channel coexistence of a first sidelink communication and a second sidelink communication, consistent with some embodiments of the present disclosure.

FIG. 2 is a block diagram of a UE, consistent with some embodiments of the present disclosure.

FIG. 3 is an example of LTE physical sidelink control channel (PSCCH)/physical sidelink shared channel (PSSCH) transmissions detected by a first RAT module, consistent with some embodiments of the present disclosure.

FIG. 4 is an example of sidelink sensing information sharing between a first RAT module and a second RAT module, consistent with some embodiments of the present disclosure.

FIG. 5 is a flowchart of a method for sidelink sensing information sharing, consistent with some embodiments of the present disclosure.

FIG. 6 is a flowchart of another method for sidelink sensing information sharing, consistent with some embodiments of the present disclosure.

### DESCRIPTION OF EMBODIMENTS

Reference will now be made in detail to exemplary embodiments, examples of which are illustrated in the drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses, systems, and methods consistent with aspects related to subject matter that may be recited in the appended claims.

Generally described, one or more aspects of the present disclosure are directed to sidelink sensing information sharing. Some embodiments of the present disclosure may apply specifically to related 3GPP Sidelink solutions, for example, 3GPP 5G NR-V2X PC5 mode 2 resource selection or 3GPP LTE-V2X PC5 mode 4 resource selection.

The physical sidelink shared channel (PSSCH) carries sidelink data in both LTE (Long Term Evolution) sidelink and new radio (NR) (5G New Radio) sidelink. In LTE and NR sidelink, sensing is performed to collect resource reservation information from other UEs and measure sidelink reference signal receive power (SL-RSRP) and sidelink received signal strength indicator (SL-RSSI) so that the transmitting UE may determine available radio resources in the selection window.

It was proposed to expand the applicability of NR sidelink and consider the vehicle-to-everything (V2X) deployment scenario where LTE V2X and NR V2X devices co-exist in the same or partially overlapping radio spectrum resources. For this co-existence, some mechanism may be created to utilize resource allocations by those two technologies in an efficient way without negatively impacting the operation of each technology.

### Device Types A, B, and C

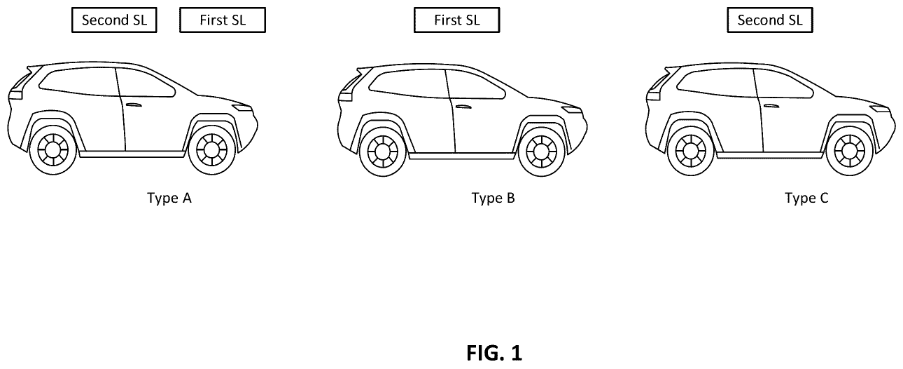

FIG. 1 is a schematic diagram illustrating device types for dynamic co-channel coexistence of a first sidelink (SL) communication and a second sidelink (SL) communication, consistent with some embodiments of the present disclosure. Referring to FIG. 1, at least three types (Type A, Type B, and Type C) of devices are considered in this disclosure. A Type A device includes a module for the first sidelink communication and a module for the second sidelink communication. A Type B device only includes a module for the first sidelink communication. A Type C device only include a module for the second sidelink communication. For example, in an embodiment, a Type A device includes both LTE SL and NR SL modules; a Type B device only includes an NR SL module; and a Type C device only includes an LTE SL module.

### User Equipment (UE)

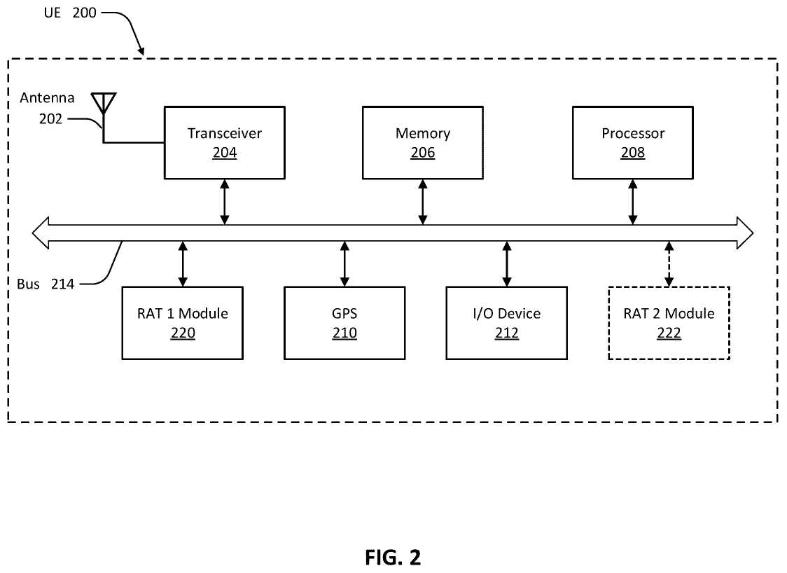

FIG. 2 is a block diagram of a UE 200, consistent with some embodiments of the present disclosure. The UE 200 may be a Type A, Type B, Type C, or any other type of UE. The UE 200 may be mounted in a moving vehicle, in a fixed position (e.g., as a roadside unit (RSU)), or may be carried by a person. The UE 200 may take any form, including but not limited to, a vehicle, a component mounted in a vehicle, a laptop computer, a wireless terminal including a mobile phone, a wireless handheld device, a wireless personal device, or any other form. Referring to FIG. 2, the UE 200 may include an antenna 202 that may be used for transmission of electromagnetic signals to and/or reception of electromagnetic signals from a base station or other UEs. The antenna 202 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 202 may include multiple (e.g., tens or hundreds) antenna elements and may enable multi-antenna functions such as beamforming. In some embodiments, the antenna 202 is a single antenna.

The UE 200 may include a transceiver 204 that is coupled to the antenna 202. The transceiver 204 may be a wireless transceiver and may communicate bi-directionally with a base station or other UEs. For example, the transceiver 204 may receive wireless signals from a base station via downlink communication and transmit wireless signals to the base station via uplink communication. The transceiver 204 may also receive wireless signals from, and transmit wireless signals to, another UE or roadside unit (RSU) via sidelink communication. The transceiver 204 may include a modem to modulate the packets and provide the modulated packets to the antenna 202 for transmission and to demodulate packets received from the antenna 202.

The UE 200 may include a memory 206. The memory 206 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 206 may store information related to identities of the UE 200 and the signals and/or data received by the antenna 202. The memory 206 may also store post-processing signals and/or data. The memory 206 may also store computer-readable program instructions, mathematical models, and algorithms that are used in signal processing in transceiver 204 and computations in a processor 208. The memory 206 may further store computer-readable program instructions for execution by the processor 208 to operate UE 200 to perform various functions described elsewhere in this disclosure. In some examples, the memory 206 may include a basic input/output system (BIOS) which may control basic hardware or software operation such as the interaction with peripheral components or devices.

The computer-readable program instructions of the present disclosure may be assembler instructions, instruction set architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 200 may include the processor 208 that may include a hardware device with processing capabilities. The processor 208 may include at least one of a general-purpose processor, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 208 may be implemented using a combination of devices (e.g., a combination of a DSP and a microprocessor, multiple microprocessors, one or more microprocessors in conjunction with a DSP core, or any other such configuration). The processor 208 may receive downlink signals or sidelink signals from the transceiver 204 and further process the signals. The processor 208 may also receive data packets from the transceiver 204 and further process the packets. In some embodiments, the processor 208 may be configured to operate a memory using a memory controller. In some embodiments, the memory controller may be integrated into the processor 208. The processor 208 may be configured to execute computer-readable instructions stored in a memory (e.g., the memory 206) to cause the UE 200 to perform various functions.

The UE 200 may include a global positioning system (GPS) 210. The GPS 210 may be used for enabling location-based services or other services based on a geographical position of the UE 200 and/or synchronization among UEs. The GPS 210 may receive global navigation satellite systems (GNSS) signals from a single satellite or a plurality of satellite signals via the antenna 202 and provide a geographical position of the UE 200 (e.g., coordinates of the UE 200).

The UE 200 may include an input/output (I/O) device 212 that may be used to communicate a result of signal processing and computation to a user or another device. The I/O device 212 may include a user interface including a display and an input device to transmit a user command to the processor 208. The display may be configured to display a status of signal reception at the UE 200, the data stored at the memory 206, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 200 may further include a machine interface 214, such as an electrical bus or communication bus that connects the transceiver 204, the memory 206, the processor 208, the GPS 210, and the I/O device 212.

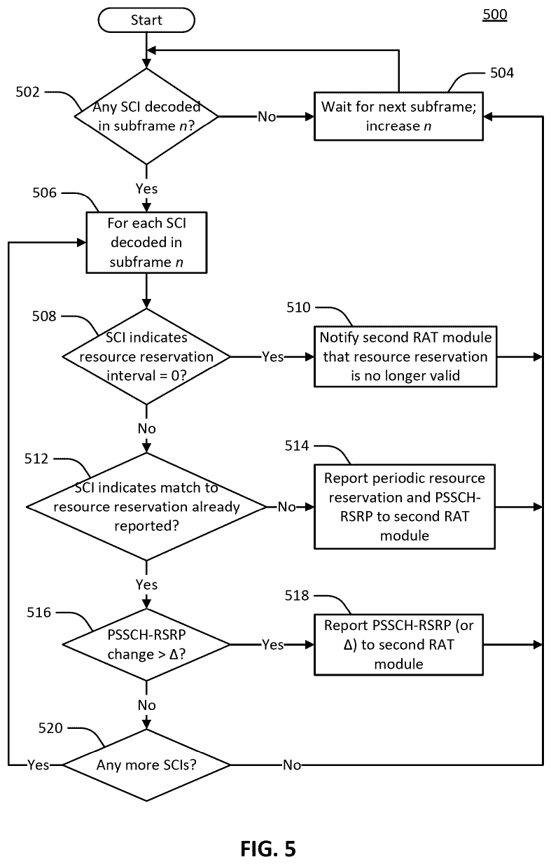

In some embodiments, the UE 200 may be configured to or programmed for sidelink communications. The processor 208 may be configured to execute the instructions stored in the memory 206 to perform a method for sidelink sensing information sharing, such as the method 500 described in connection with FIG. 5.

In an embodiment where the UE 200 is a Type A UE, the UE 200 may include a first radio access technology (RAT 1) module 220 in communication with the bus 214 and a second radio access technology (RAT 2) module 222 in communication with the bus 214. In some embodiments, RAT 1 module 220 may be configured to implement a first RAT, for example, LTE SL. In some embodiments, RAT 2 module 222 may be configured to implement a second RAT, different from the first RAT, for example, NR SL. It is noted that the types of RATs implemented by the RAT modules 220, 222 are not limited to LTE SL and NR SL. The RAT modules 220, 222 may implement any type of RAT without changing the principles of operation of the embodiments described herein.

In an embodiment where the UE 200 is a Type B UE or a Type C UE, the UE 200 may include only one RAT module (e.g., RAT 1 module 220). RAT 1 module 220 may implement any type of RAT, e.g., LTE SL, NR SL, or other type of RAT. In FIG. 2, RAT 2 module 222 is shown in dashed outline to indicate that it may not be included in some embodiments.

### Reporting of Sensing and Resource Reservation Information

Some embodiments of the present disclosure involve a method to reduce data rate requirements for sharing sensing and resource reservation information from a first radio access technology (RAT) module (e.g., an LTE V2X module) to a second RAT module (e.g., an NR V2X module). Some embodiments of the present disclosure describe the first RAT module as an LTE module and the second RAT module as an NR module. It is noted that the embodiments described herein work in a similar manner with different types of RAT modules, i.e., RATs different than LTE and/or NR. For purposes of discussion, the term “first RAT module” may refer to an LTE V2X module and the term “second RAT module” may refer to an NR V2X module. As noted, the RAT associated with a particular RAT module may vary and is not limited to LTE and NR.

In some current implementations, continuous reporting of LTE sensing information was assumed. After each subframe n, the first RAT module shared sensing and resource reservation information related to LTE SCI(s) (if any) decoded in subframe n with the second RAT module. This approach had the benefit that the information arrived at the second RAT module as fast as possible. Thus, the second RAT module had the most up-to-date information from the first RAT module when performing resource exclusion for NR sidelink transmission.

With sidelink, there may be no network control of radio resources, so resource allocation may be performed autonomously at each UE. The resource allocation is based on sensing the transmission medium based on resource exclusion thresholds (e.g., RSRP and RSSI) during a sensing window. If resource exclusion reveals no available resources for the UE to transmit on, the UE adjusts the resource exclusion thresholds and performs the resource exclusion again to find available resources. Some UEs (e.g., a Type A UE described in connection with FIG. 1) may include two different RAT modules. Different RATs have different frame structures and waveforms, and each RAT would perform its own sensing and resource exclusion to determine available radio resources for transmission. In a vehicle-based implementation, because a vehicle is designed to be used for at least 10-15 years and since RATs are constantly evolving, there may be multiple RATs (e.g., separate RAT modules for each RAT). By sharing resource information between the different RAT modules, bandwidth use on an internal vehicle communications bus may be reduced.

In some embodiments, the UE is implemented in a vehicle and the sensing and resource reservation information may be communicated via a vehicle-internal interface (e.g., an internal communications bus, for example, bus 214) for co-channel co-existence of LTE V2X and NR V2X. For each sidelink control information (SCI) decoded in a given subframe, the first RAT module determines whether the decoded SCI matches periodic resource reservation information already shared with the second RAT module. In case of a match, the first RAT module may refrain from sharing redundant sensing and/or resource reservation information with the second RAT module. Not sharing redundant information may reduce data rate requirements for such information sharing and may minimize the impact to/from legacy applications concurrently using the vehicle-internal interface.

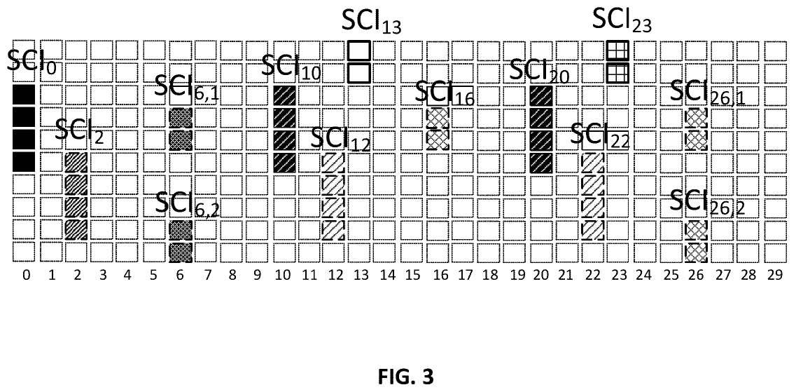

FIG. 3 shows an example of LTE physical sidelink control channel (PSCCH)/physical sidelink shared channel (PSSCH) transmissions detected by the first RAT module, consistent with some embodiments of the present disclosure. One feature of such transmissions is that they are often periodic (or semi-persistent), as they are typically used for transmission of periodic safety-related messages such as cooperative awareness messages (CAM) and basic safety messages (BSM). For example as shown in FIG. 3, the LTE PSCCH/PSSCH transmission detected in subframe 0 recurs periodically every 10 subframes (indicated by SCI₀, SCI₁₀, SCI₂₀, etc.). Thus, it would be redundant for the first RAT module to report SCI and PSSCH reference signal received power (PSSCH-RSRP) information for every instance of a periodic LTE PSCCH/PSSCH transmission.

In some embodiments, for each SCI decoded in a given subframe n, the first RAT module determines whether a resource indicated by the decoded SCI matches a periodic resource reservation previously reported to the second RAT module. If there is no match, the first RAT module reports the associated SCI and PSSCH-RSRP information to the second RAT module. However, if a match is found, the first RAT module may refrain from reporting the associated SCI and/or PSSCH-RSRP information to reduce the load on the vehicle-internal interface.

For example, referring to FIG. 3, immediately after subframe 0, the first RAT module may report SCI₀ and the corresponding PSSCH-RSRP to the second RAT module. The reported SCI₀ indicates a resource reservation interval (P_{rsvp,TX}) of 10 subframes. Later on, in subframe 10, the first RAT module decodes SCI₁₀ and determines a match with the periodic resource reservation previously reported in connection with SCI₀. In addition, the PSSCH-RSRP measured in subframe 10 may be similar to that which was measured in subframe 0, e.g., if the vehicle which transmitted those SCIs was the same and has not moved significantly relative to the sensing vehicle. Thus, the first RAT module may refrain from reporting any information in connection with SCI₁₀ to the second RAT module. The same may be applied later on, in subframe 20, when the first RAT module decodes SCI₂₀.

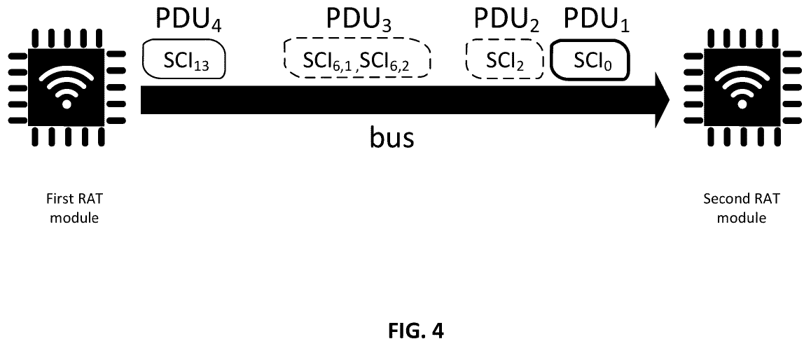

In this way, the amount of LTE sensing and resource reservation information transmitted on the vehicle-internal interface may be reduced, as illustrated in FIG. 4, where only SCI₀, SCI₂, etc. (and the corresponding PSSCH-RSRPs) are shared over a bus via respective PDUs. It is noted that the repetitive information (e.g., the information in SCI₁₀, SCI₂₀, etc.) is not reported.

Due to, e.g., non-zero relative velocity between vehicles, the measured PSSCH-RSRP may change across different instances of a same periodic (or semi-persistent) LTE PSCCH/PSSCH transmission. For instance, if the vehicle transmitting SCI₀ is approaching the sensing vehicle, it is likely that the PSSCH-RSRP associated with SCI₁₀ will be higher than that which was measured for SCI₀, and the PSSCH-RSRP associated with SCI₂₀ will be even higher, and so on. Conversely, if the vehicle transmitting SCI₀ is receding, it is likely that the PSSCH-RSRP associated with SCI₁₀ will be lower, and so on.

According to one embodiment, the first RAT module may monitor PSSCH-RSRP changes across instances of a periodic transmission and update the second RAT module whenever the PSSCH-RSRP has changed significantly (e.g., greater than a PSSCH-RSRP change threshold Δ) compared to the last reported PSSCH-RSRP. For example, the first RAT module may decode SCI₅₀ (not shown in FIG. 3) and determine that it matches the periodic resource reservation indicated by SCI₀ but that the PSSCH-RSRP has increased (or decreased) by more than, e.g., Δ=1 dB compared to the PSSCH-RSRP reported for SCI₀ (which was the last reported PSSCH-RSRP for this periodic transmission). Then, the first RAT module may report the updated PSSCH-RSRP or the determined increase (or decrease) to the second RAT module. In this way, the second RAT module obtains accurate PSSCH-RSRP information while the load on the transmission bus is minimized.

According to one embodiment, the PSSCH-RSRP change threshold Δ may depend on whether the observed change is an increase (Δ₊) or decrease (Δ₋) in PSSCH-RSRP. For example, the PSSCH-RSRP increase threshold Δ₊ may be smaller (e.g., Δ₊=1 dB) than the PSSCH-RSRP decrease threshold Δ₋ (e.g., Δ₋=3 dB). This is motivated by the different impact of using a stale PSSCH-RSRP value that is lower versus higher than the latest PSSCH-RSRP value measured by the first RAT module. If a stale PSSCH-RSRP value is used by the second RAT module which is lower than the latest measured value, candidate resources which might otherwise have been excluded for NR sidelink transmission may not be excluded, thus degrading co-existence performance. On the other hand, if a stale PSSCH-RSRP value is used by the second RAT module which is higher than the latest measured value, candidate resources which might otherwise not have been excluded for NR sidelink transmission may be excluded (i.e., the second RAT module may be more conservative by over-excluding candidate resources).

According to one embodiment, the PSSCH-RSRP change/increase/decrease threshold (Δ, Δ₊, Δ₋) may depend on a channel congestion level (e.g., channel busy ratio (CBR)) measured by the first RAT module and/or the second RAT module. For example, if the channel is highly congested (e.g., high CBR), resource over-exclusion caused by stale PSSCH-RSRP values that are higher than the latest measured values (as described above) may cause the second RAT module to increase the RSRP threshold used for resource exclusion to provide the medium access control (MAC) layer with a minimum ratio of remaining candidate resources from which to select randomly. Thus, when the channel is congested, using stale PSSCH-RSRP values that are higher than the latest measured values may become as problematic as using stale PSSCH-RSRP values that are lower. To address this issue, the PSSCH-RSRP decrease threshold (Δ₋) may be smaller (e.g., Δ₋=1 dB) when channel congestion increases. According to one embodiment, the PSSCH-RSRP change/increase/decrease threshold (Δ, Δ₊, Δ₋) may be adapted based on congestion or load on the vehicle-internal interface. For example, if the interface is relatively idle, smaller thresholds (Δ, Δ₊, Δ₋) may be used (e.g., Δ=0.5 dB). On the other hand, if the interface is highly congested (e.g., due to it being concurrently used by other bandwidth-intensive vehicle applications), larger thresholds (Δ, Δ₊, Δ₋) may be used (e.g., Δ=3 dB).

According to one embodiment, the first RAT module may detect the end of a periodic resource reservation (e.g., as a result of resource reselection having been triggered at the transmitting vehicle) by decoding an SCI indicating a resource reservation interval of zero. For example, in subframe 90, the first RAT module may decode SCI₉₀ and determine that it matches the periodic resource reservation indicated by SCI₀ but that the indicated resource reservation interval is zero. This is then interpreted by the sensing vehicle as an indication that the periodic resource reservation associated with SCI₀ is no longer valid (i.e., the respective future periodic resources are no longer reserved), and the second RAT module may be notified correspondingly.

According to one embodiment, the first RAT module may detect the absence of one or more expected, periodic SCI(s) consecutively and notify the second RAT module that the corresponding periodic resource reservation is no longer detectable. This may occur as a result of the transmitting vehicle getting increasingly farther from the sensing vehicle, so that the sensing vehicle is no longer able to decode the transmitted SCIs. To avoid one-time or temporary SCI decoding failures (e.g., due to brief obstructions caused by nearby vehicles), the first RAT module may notify the second RAT module of such events only after a minimum number of expected (periodic) SCIs are not detected. A previous gradual decrease in the measured PSSCH-RSRP may be used as a further indication that the transmitting vehicle has likely moved beyond the sensing vehicle's SCI detection range.

According to one embodiment, if the first RAT module detects the absence of one or more expected, periodic SCI(s) consecutively, where the resource reservation interval is 100 milliseconds (ms) or larger, and notifies the second RAT module of that event, the second RAT module may determine that the corresponding periodic resource reservation is no longer valid (i.e., the respective future periodic resources are no longer reserved) because the chain of resource reservation is broken due to the absence of one or more expected, periodic SCI(s) at the first RAT module. This is due to the fact that in LTE V2X, one SCI can reserve resources for the next transport block (TB) but cannot reserve resources for the following TBs after the next TB if the resource reservation interval is 100 ms or larger.

According to one embodiment, the second RAT module may implicitly infer the end of a periodic resource reservation by using a timer. Upon reception of an SCI report from the first RAT module indicating a periodic resource reservation, the second RAT module may start a timer associated with the periodic resource reservation. The timer may be restarted whenever the first RAT module reports any information about the periodic resource reservation to the second RAT module. If the timer expires, the second RAT module considers that the periodic resource reservation is no longer valid.

In some embodiments, a RAT module in the UE (e.g., RAT 1 module 220 shown in FIG. 2) may request sensing information from another RAT module (e.g., RAT 2 module 222) or from another UE (e.g., from an RAT in another UE). The sensing information request may include position information for the requesting UE. For example, the position information may be vague (e.g., a general location of the requesting UE), may be based on a shape of the cell of the RAT, or may include specific information (e.g., GPS position coordinates). In some embodiments, the more accurate the position information is in the sensing information request, the more accurate the response may be (e.g., more accurate sensing information with respect to the current position of the requesting UE).

In some embodiments, the sensing information request sent by the requesting UE may be received by multiple receiver UEs. In such circumstances, the requesting UE may receive responses from all receiver UEs and may combine this information. For example, the requesting UE may combine the sensing information based on majority weighting or averaging.

FIG. 5 is a flowchart of a method 500 for sidelink sensing information sharing between a first RAT module and a second RAT module, consistent with some embodiments of the present disclosure. At the first RAT module, a determination is made whether there is any sidelink control information (SCI) decoded in a current subframe (e.g., subframe number n) (step 502). If there is no SCI decoded in the current subframe (step 502, “no” branch), then the method 500 waits for the next subframe and increments n (step 504) and continues with step 502 as described above.

If there is at least one SCI decoded in the current subframe (step 502, “yes” branch), then the method 500 progresses for each SCI decoded in the current subframe (step 506) and iterates with additional steps, as shown in FIG. 5. The first RAT module examines the SCI to determine whether the SCI indicates that the resource reservation interval is zero (step 508), which indicates that resource reselection has been triggered in the current subframe. If the resource reservation interval is zero (step 508, “yes” branch), then the first RAT module notifies the second RAT module that the periodic resource reservation is no longer valid (step 510) and the method 500 waits for the next subframe and increments n (step 504) and continues with step 502 as described above.

If the resource reservation interval is not zero (step 508, “no” branch), then a determination is made whether the SCI indicates whether a resource matching the periodic resource reservation was already reported to the second RAT module (step 512). If a resource matching the periodic resource reservation was not already reported to the second RAT module (step 512, “no” branch), then the first RAT module reports the periodic resource reservation information and the PSSCH-RSRP associated with the SCI to the second RAT module (step 514). The method 500 waits for the next subframe and increments n (step 504) and continues with step 502 as described above.

If a resource matching the periodic resource reservation was already reported to the second RAT module (step 512, “yes” branch), then a determination is made whether the PSSCH-RSRP change is greater than a predetermined threshold (e.g., Δ, Δ₊, or Δ₋) (step 516). If the PSSCH-RSRP change is greater than the predetermined threshold (step 516, “yes” branch), then the first RAT module reports the current PSSCH-RSRP or the change (i.e., Δ) to the second RAT module (step 518). The method 500 waits for the next subframe and increments n (step 504) and continues with step 502 as described above.

If the PSSCH-RSRP change is less than or equal to the predetermined threshold (step 516, “no” branch), then no information is reported to the second RAT module. A determination is made whether there are any more SCIs in the current subframe (step 520). If there are more SCIs in the current subframe (step 520, “yes” branch), then the next SCI in the subframe is analyzed as described in connection with steps 508-518. If there are no more SCIs in the current subframe (step 520, “no” branch), then the method 500 waits for the next subframe and increments n (step 504) and continues with step 502 as described above.

Information (sensing and/or resource reservation) reported from the first RAT module to the second RAT module may include any time-domain and/or frequency-domain information (e.g., slot, subframe, frame, subchannel, carrier, resource pool, etc.). It may include one or more of the already standardized SCI format 1 fields defined in 3GPP Technical Specification 36.212 for LTE V2X, namely: priority, resource reservation, frequency resource location of initial transmission and retransmission, time gap between initial transmission and retransmission, modulation and coding scheme, retransmission index, and/or transmission format.

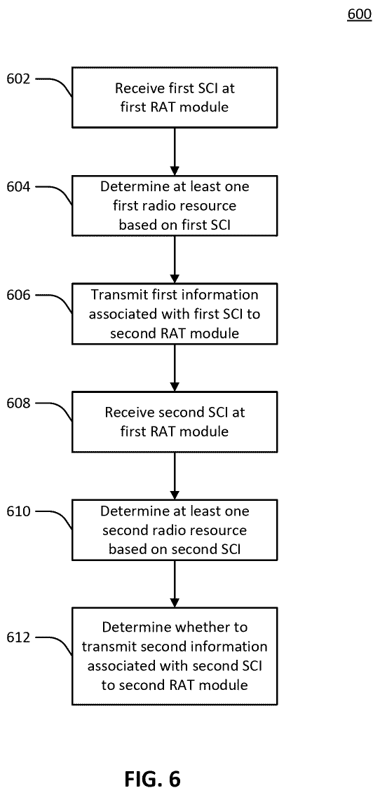

FIG. 6 is a flowchart of a method 600 for sidelink sensing information sharing, consistent with some embodiments of the present disclosure. First sidelink control information (SCI) is received at a first radio access technology (RAT) module of a UE (step 602). The first SCI may include radio resource reservation information, as described elsewhere in this disclosure. The first RAT module may be configured to implement a first RAT, as described elsewhere in this disclosure.

At least one first radio resource is determined based on the first SCI (step 604). The first radio resource may be a radio resource used by the UE to transmit on. First information associated with the first SCI is transmitted to a second RAT module (step 606). The second RAT module may be configured to implement a second RAT, different from the first RAT, as described elsewhere in this disclosure. For example, the first information may include a first received signal measurement associated with the first SCI (e.g., a received signal strength associated with the first SCI) or a first physical sidelink reference signal received power associated with the first SCI.

Second SCI is received at the first RAT module (step 608). The second SCI may include radio resource reservation information, as described elsewhere in this disclosure. At least one second radio resource is determined based on the second SCI (step 610). A determination is made whether to transmit second information associated with the second SCI to the second RAT module (step 612). The determination may be based on at least whether the determined at least one first radio resource matches the determined at least one second radio resource. In some embodiments, determining whether to transmit the second information may be further based on at least a second received signal measurement associated with the second SCI. The second received signal measurement may include a received signal strength measurement, a second physical sidelink reference signal measurement associated with the second SCI, or a received signal power measurement. For example, at least one of the first received signal measurement or the second received signal measurement may be a received signal strength measurement.

In some embodiments, determining the at least one first radio resource may be based on a first resource reservation interval indicated by the first SCI. The determined at least one first radio resource may occur an integer multiple of the first resource reservation interval after a subframe in which the first SCI is received.

In some embodiments, the method may further include determining a difference between the first received signal measurement and the second received signal measurement and transmitting the second information to the second RAT module on a condition that the determined difference is greater than a threshold. The second information may include the difference. In some embodiments, the threshold may depend on a sign of the difference, on a channel busy ratio determined by the first RAT module or the second RAT module, or on an observed congestion level or a load of a communication interface between the first RAT module and the second RAT module.

In some embodiments, the first information may include a radio resource reservation index identifying a periodic radio resource reservation associated with the first SCI. The second information may include a radio resource reservation index identifying a periodic radio resource reservation associated with the first SCI.

In some embodiments, the method may further include transmitting the second information associated with the second SCI to the second RAT module based on the determination whether to transmit the second information.

In some embodiments, the method may further include incrementing a radio resource reservation index counter by the first RAT module each time information is transmitted or received without a radio resource reservation index.

In some embodiments, the method may further include incrementing a radio resource reservation index counter by the second RAT module each time information is transmitted or received without a radio resource reservation index.

In some embodiments, the method may further include transmitting third information from the first RAT module to the second RAT module, wherein the third information is indicative of an end of a periodic radio resource reservation associated with the first SCI. The third information may be based on at least one of a second radio resource reservation interval indicated by the second SCI is zero, or the first RAT module fails to receive a configured number of expected SCIs consecutively.

In some embodiments, the method may further include determining, by the second RAT module and based on the third information, that the periodic radio resource reservation associated with the first SCI is no longer valid. In some embodiments, the method may further include determining, by the second RAT module, an end of the periodic radio resource reservation associated with the first SCI based on a timer expiring.

### Resource Reservation Index

In some embodiments, a resource reservation index or resource reservation identifier (ID) may be reported by the first RAT module along with the resource reservation information. This indicates that the reported resource reservation information is associated with the reported resource reservation index. For subsequent reports from the first RAT module to the second RAT module (e.g., used to indicate a change of PSSCH-RSRP with respect to a previously reported PSSCH-RSRP), only the resource reservation index may need to be reported.

The resource reservation index may be an optional parameter or field. The first RAT module may explicitly indicate whether a “resource reservation index” parameter or field is reported. In some embodiments, the resource reservation associated with a resource reservation index may be overwritten by reporting a different resource reservation with a resource reservation index that corresponds to a previously used resource reservation index.

In some embodiments, when information (sensing and/or resource reservation) is reported from the first RAT module to the second RAT module, the resource reservation index may not be transmitted but instead created at both the first RAT module and second RAT module by incrementing a resource reservation index counter. The counter may be incremented each time a resource reservation is reported without a resource reservation index.

An association between a resource reservation and a resource reservation index may be erased after a specific time and/or after a certain resource reservation index is reached, and/or by using an explicit indication from the first RAT module to the second RAT module. In some embodiments, a resource reservation index may take the value ‘0’ when a new association is created and/or when a maximum resource reservation index is reached or exceeded. Other start values are possible (for example, ‘1’).

While the examples in the present disclosure refer to a first RAT module providing information to a second RAT module, embodiments herein may be used in the opposite direction (the second RAT module providing information to the first RAT module). While LTE and NR are used as example radio access technologies (RATs) in some embodiments described in this disclosure, the embodiments described herein may also be applicable to other RATs (for example, 6G).

Any of the embodiments described herein may be used simultaneously or in combination. The combination of various embodiments may be controlled by one or more parameters with the same embodiments as described herein with regards to providing those parameters to the UE. In another embodiment, any embodiment described herein may apply conditionally to the UE being in a sidelink co-existence setting.

Any embodiment described herein may apply conditionally to the UE operating in the same resource pool or carrier frequency as the one being detected.

Any of the embodiments described in this disclosure may apply to 3GPP Sidelink. This may, for example, apply to Release 18 NR Sidelink and/or Release 18 LTE-NR Sidelink co-existence (for example, for Sidelink in Unlicensed access). However, the embodiments described in this disclosure are not restricted to this technology and may apply to other wireless communication technologies, for example and not limited to, Digital Enhanced Cordless Telecommunications/Digital European Cordless Telecommunications (DECT) or IEEE 802.11, for example, Wi-Fi.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise,” “include,” or “contain” may be used interchangeably and have the same meaning and are to be construed as inclusive and open-ending. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance, or an example.” By reading this disclosure, including the description of the embodiments and the drawings, it will be appreciated by a person of ordinary skill in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment,” “some embodiments,” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated to explain the nature of described embodiments may be made by those skilled in the art without departing from the scope of this disclosure. Accordingly, the following claims embrace all such alternatives, modifications, and variations that fall within the terms of the claims.

Clause 1. A method for sharing radio resource information, comprising:
receiving first sidelink control information (SCI) at a first radio access technology (RAT) module, wherein the first RAT module is configured to implement a first RAT;
determining at least one first radio resource based on the first SCI;
transmitting first information associated with the first SCI to a second RAT module, wherein the second RAT module is configured to implement a second RAT, the second RAT being different from the first RAT;
receiving second SCI at the first RAT module;
determining at least one second radio resource based on the second SCI; and
determining whether to transmit second information associated with the second SCI to the second RAT module based on at least whether the determined at least one first radio resource matches the determined at least one second radio resource.

Clause 2. The method of clause 1, wherein determining the at least one first radio resource is based on a first resource reservation interval indicated by the first SCI.

Clause 3. The method of clause 2, wherein the determined at least one first radio resource occurs an integer multiple of the first resource reservation interval after a subframe in which the first SCI is received.

Clause 4. The method of clause 1, wherein the transmitted first information includes a first received signal measurement associated with the first SCI.

Clause 5. The method of clause 4, wherein the first received signal measurement includes a first physical sidelink reference signal received power associated with the first SCI.

Clause 6. The method of clause 4, wherein determining whether to transmit the second information is further based on at least a second received signal measurement associated with the second SCI.

Clause 7. The method of clause 6, wherein at least one of the first received signal measurement or the second received signal measurement is a received signal strength measurement.

Clause 8. The method of clause 6, wherein the second received signal measurement includes a second physical sidelink reference signal measurement associated with the second SCI.

Clause 9. The method of clause 8, wherein the second physical sidelink reference signal measurement is a received signal power measurement.

Clause 10. The method of clause 6, further comprising:
determining a difference between the first received signal measurement and the second received signal measurement; and
transmitting the second information to the second RAT module on a condition that the determined difference is greater than a threshold.

Clause 11. The method of clause 10, wherein the second information includes the difference.

Clause 12. The method of clause 10, wherein the threshold depends on a sign of the difference.

Clause 13. The method of clause 10, wherein the threshold depends on a channel busy ratio determined by the first RAT module or the second RAT module.

Clause 14. The method of clause 10, wherein the threshold depends on an observed congestion level or a load of a communication interface between the first RAT module and the second RAT module.

Clause 15. The method of clause 1, wherein the first information includes a radio resource reservation index identifying a periodic radio resource reservation associated with the first SCI.

Clause 16. The method of clause 1, wherein the second information includes a radio resource reservation index identifying a periodic radio resource reservation associated with the first SCI.

Clause 17. The method of clause 1, further comprising:
transmitting the second information associated with the second SCI to the second RAT module based on the determination whether to transmit the second information.

Clause 18. The method of clause 1, further comprising:
incrementing a radio resource reservation index counter by the first RAT module each time information is transmitted or received without a radio resource reservation index.

Clause 19. The method of clause 1, further comprising:
incrementing a radio resource reservation index counter by the second RAT module each time information is transmitted or received without a radio resource reservation index.

Clause 20. The method of clause 1, further comprising:
transmitting third information from the first RAT module to the second RAT module, wherein the third information is indicative of an end of a periodic radio resource reservation associated with the first SCI.

Clause 21. The method of clause 20, wherein the third information is based on at least one of:
a second radio resource reservation interval indicated by the second SCI is zero; or
the first RAT module fails to receive a configured number of expected SCIs consecutively.

Clause 22. The method of clause 20, further comprising:
determining, by the second RAT module and based on the third information, that the periodic radio resource reservation associated with the first SCI is no longer valid.

Clause 23. The method of clause 22, further comprising:
determining, by the second RAT module, an end of the periodic radio resource reservation associated with the first SCI based on a timer expiring.

Clause 24. A user equipment (UE) for sharing radio resource information, the UE comprising:
a memory configured to store instructions; and
a processor configured to execute the instructions stored in the memory to:
   receive first sidelink control information (SCI) at a first radio access technology (RAT) module in the UE, wherein the first RAT module is configured to implement a first RAT;
   determine at least one first radio resource based on the first SCI;
   transmit first information associated with the first SCI to a second RAT module, wherein the second RAT module is configured to implement a second RAT, the second RAT being different from the first RAT;
   receive second SCI at the first RAT module;
   determine at least one second radio resource based on the second SCI; and
   determine whether to transmit second information associated with the second SCI to the second RAT module based on at least whether the determined at least one first radio resource matches the determined at least one second radio resource.

Clause 25. The UE of clause 24, wherein the processor is further configured to:
determine the at least one first radio resource based on a first resource reservation interval indicated by the first SCI.

Clause 26. The UE of clause 25, wherein the determined at least one first radio resource occurs an integer multiple of the first resource reservation interval after a subframe in which the first SCI is received.

Clause 27. The UE of clause 24, wherein the transmitted first information includes a first received signal measurement associated with the first SCI.

Clause 28. The UE of clause 27, wherein the first received signal measurement includes a first physical sidelink reference signal received power associated with the first SCI.

Clause 29. The UE of clause 27, wherein the processor is further configured to:
determine whether to transmit the second information further based on at least a second received signal measurement associated with the second SCI.

Clause 30. The UE of clause 29, wherein at least one of the first received signal measurement or the second received signal measurement is a received signal strength measurement.

Clause 31. The UE of clause 29, wherein the second received signal measurement includes a second physical sidelink reference signal measurement associated with the second SCI.

Clause 32. The UE of clause 31, wherein the second physical sidelink reference signal measurement is a received signal power measurement.

Clause 33. The UE of clause 29, wherein the processor is further configured to:
determine a difference between the first received signal measurement and the second received signal measurement; and
transmit the second information to the second RAT module on a condition that the determined difference is greater than a threshold.

Clause 34. The UE of clause 33, wherein the second information includes the difference.

Clause 35. The UE of clause 33, wherein the threshold depends on a sign of the difference.

Clause 36. The UE of clause 33, wherein the threshold depends on a channel busy ratio determined by the first RAT module or the second RAT module.

Clause 37. The UE of clause 33, wherein the threshold depends on an observed congestion level or a load of a communication interface between the first RAT module and the second RAT module.

Clause 38. The UE of clause 24, wherein the first information includes a radio resource reservation index identifying a periodic radio resource reservation associated with the first SCI.

Clause 39. The UE of clause 24, wherein the second information includes a radio resource reservation index identifying a periodic radio resource reservation associated with the first SCI.

Clause 40. The UE of clause 24, wherein the processor is further configured to:
transmit the second information associated with the second SCI to the second RAT module based on the determination whether to transmit the second information.

Clause 41. The UE of clause 24, wherein the processor is further configured to:
increment a radio resource reservation index counter by the first RAT module each time information is transmitted or received without a radio resource reservation index.

Clause 42. The UE of clause 24, wherein the processor is further configured to:
increment a radio resource reservation index counter by the second RAT module each time information is transmitted or received without a radio resource reservation index.

Clause 43. The UE of clause 24, wherein the processor is further configured to:
transmit third information from the first RAT module to the second RAT module, wherein the third information is indicative of an end of a periodic radio resource reservation associated with the first SCI.

Clause 44. The UE of clause 43, wherein the third information is based on at least one of:
a second radio resource reservation interval indicated by the second SCI is zero; or
the first RAT module fails to receive a configured number of expected SCIs consecutively.

Clause 45. The UE of clause 43, wherein the processor is further configured to:
determine, by the second RAT module and based on the third information, that the periodic radio resource reservation associated with the first SCI is no longer valid.

Clause 46. The UE of clause 45, wherein the processor is further configured to:
determine, by the second RAT module, an end of the periodic radio resource reservation associated with the first SCI based on a timer expiring.

Clause 47. A non-transitory computer-readable medium storing instructions that are executable by one or more processors of a user equipment (UE) in a communication network to perform a method for sharing radio resource information, the method comprising:
receiving first sidelink control information (SCI) at a first radio access technology (RAT) module in the UE, wherein the first RAT module is configured to implement a first RAT;
determining at least one first radio resource based on the first SCI;
transmitting first information associated with the first SCI to a second RAT module, wherein the second RAT module is configured to implement a second RAT, the second RAT being different from the first RAT;
receiving second SCI at the first RAT module;
determining at least one second radio resource based on the second SCI; and
determining whether to transmit second information associated with the second SCI to the second RAT module based on at least whether the determined at least one first radio resource matches the determined at least one second radio resource.

1. A method for sharing radio resource information, comprising:
receiving first sidelink control information (SCI) at a first radio access technology (RAT) module, wherein the first RAT module is configured to implement a first RAT;
determining at least one first radio resource based on the first SCI;
transmitting first information associated with the first SCI to a second RAT module, wherein the second RAT module is configured to implement a second RAT, the second RAT being different from the first RAT;
receiving second SCI at the first RAT module;
determining at least one second radio resource based on the second SCI; and
determining whether to transmit second information associated with the second SCI to the second RAT module based on at least whether the determined at least one first radio resource matches the determined at least one second radio resource.

2. The method of claim 1, wherein determining the at least one first radio resource is based on a first resource reservation interval indicated by the first SCI.

3. The method of claim 2, wherein the determined at least one first radio resource occurs an integer multiple of the first resource reservation interval after a subframe in which the first SCI is received.

4. The method of claim 1, wherein the transmitted first information includes a first received signal measurement associated with the first SCI.

5. The method of claim 4, wherein the first received signal measurement includes a first physical sidelink reference signal received power associated with the first SCI.

6. The method of claim 4, wherein determining whether to transmit the second information is further based on at least a second received signal measurement associated with the second SCI.

7. The method of claim 6, wherein at least one of the first received signal measurement or the second received signal measurement is a received signal strength measurement.

8. The method of claim 6, wherein the second received signal measurement includes a second physical sidelink reference signal measurement associated with the second SCI.

9. The method of claim 6, further comprising:
determining a difference between the first received signal measurement and the second received signal measurement; and
transmitting the second information to the second RAT module on a condition that the determined difference is greater than a threshold.

10. The method of claim 1, wherein the first information includes a radio resource reservation index identifying a periodic radio resource reservation associated with the first SCI.

11. The method of claim 1, wherein the second information includes a radio resource reservation index identifying a periodic radio resource reservation associated with the first SCI.

12. The method of claim 1, further comprising:
transmitting the second information associated with the second SCI to the second RAT module based on the determination whether to transmit the second information.

13. The method of claim 1, further comprising:
incrementing a radio resource reservation index counter by the first RAT module each time information is transmitted or received without a radio resource reservation index.

14. The method of claim 1, further comprising:
incrementing a radio resource reservation index counter by the second RAT module each time information is transmitted or received without a radio resource reservation index.

15. The method of claim 1, further comprising:
transmitting third information from the first RAT module to the second RAT module, wherein the third information is indicative of an end of a periodic radio resource reservation associated with the first SCI.

16. The method of claim 15, wherein the third information is based on at least one of:
a second radio resource reservation interval indicated by the second SCI is zero; or
the first RAT module fails to receive a configured number of expected SCIs consecutively.

17. The method of claim 15, further comprising:
determining, by the second RAT module and based on the third information, that the periodic radio resource reservation associated with the first SCI is no longer valid.

18. The method of claim 17, further comprising:
determining, by the second RAT module, an end of the periodic radio resource reservation associated with the first SCI based on a timer expiring.

19. A user equipment (UE) for sharing radio resource information, the UE comprising:
a memory configured to store instructions; and
a processor configured to execute the instructions stored in the memory to:
receive first sidelink control information (SCI) at a first radio access technology (RAT) module in the UE, wherein the first RAT module is configured to implement a first RAT;
determine at least one first radio resource based on the first SCI;
transmit first information associated with the first SCI to a second RAT module, wherein the second RAT module is configured to implement a second RAT, the second RAT being different from the first RAT;
receive second SCI at the first RAT module;
determine at least one second radio resource based on the second SCI; and
determine whether to transmit second information associated with the second SCI to the second RAT module based on at least whether the determined at least one first radio resource matches the determined at least one second radio resource.

20. A non-transitory computer-readable medium storing instructions that are executable by one or more processors of a user equipment (UE) in a communication network to perform a method for sharing radio resource information, the method comprising:
receiving first sidelink control information (SCI) at a first radio access technology (RAT) module in the UE, wherein the first RAT module is configured to implement a first RAT;
determining at least one first radio resource based on the first SCI;
transmitting first information associated with the first SCI to a second RAT module, wherein the second RAT module is configured to implement a second RAT, the second RAT being different from the first RAT;
receiving second SCI at the first RAT module;
determining at least one second radio resource based on the second SCI; and
determining whether to transmit second information associated with the second SCI to the second RAT module based on at least whether the determined at least one first radio resource matches the determined at least one second radio resource.
